(19) United States
(12) Patent Application Publication
(10) Pub. No.: US 2005/0212892 A1
(43) Pub. Date: Sep. 29, 2005

(54) Device and method for cleaning thermal head

(75) Inventor: Masato Iso, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,466

(22) Filed: Mar. 29, 2005

(30) Foreign Application Priority Data
Mar. 29, 2004 (JP) 2004-096905

(51) Int. Cl. B41J 2/315; B41J 2/32

(52) U.S. Cl. 347/179

(57) ABSTRACT

A platen roller is disposed opposite to a thermal head. In a head cleaning operation, a cleaning sheet rubs the vicinity area of a partial glaze, as pushed by the platen roller. Two types of bearings, a normal bearing with no eccentricity and an eccentric bearing, are attached to a rotary axis of the platen roller. The eccentric bearing is applied in the head cleaning operation. When the platen roller rotates, the rotary axis eccentrically rotates and reciprocates the platen roller in a vertical and a sub-scanning directions.

### BACKGROUND OF THE INVENTION

1. Field of the Invention

The present invention relates to a head cleaning device provided in a thermal printer and a head cleaning method.

2. Background Arts

A thermal printer is well known to thermally record an image on a thermal recording paper, which develops colors upon the application of heat energy, with the heat of the thermal head. The thermal head comprising a glaze layer, which is made of glazed glass, formed on a ceramic substrate and a heating element array including a plurality of heating elements aligned in a main scanning direction on the glaze layer. The heating element array is pressed against the thermal recording paper and heats it. In order to enhance contact between the heating element array and the thermal recording paper, a part of the glaze layer protrudes cylindrically and the heating element array is disposed on approximately top of the protruding area (hereinafter referred to as a partial glaze).

The thermal head is heated to a high temperature during recording and causes a protective layer on the surface of the thermal recording paper to be softened and stain around the partial glaze. Since the stain deteriorates the image, the thermal head needs to be cleaned and, for example, a cleaning sheet coated with abrasive is fed to the printer.

A platen roller is located opposite to the thermal head to push the thermal recording paper to the heating element array. The lengthwise periphery of the platen roller faces the approximate top of the partial glaze so as to push the thermal recording paper to the heating element array. In the head cleaning method disclosed in Japanese Patent Laid-Open Publication Number 2003-326751, for example, the platen roller pushes the cleaning sheet to the heating element array while the cleaning sheet is transported on a transportation path past the thermal head. The cleaning sheet thus rubs the stain off the heating element array.

The stains spread from the heating element array and to the front and the rear areas thereof on the thermal head in the transporting direction. It is necessary to clean such areas as well because the stains on those areas have an adverse affect on the heat characteristic of the heating element. However, the cleaning sheet contacts only a limited area of the partial glaze because both the partial glaze and the platen roller have circular peripheries, and cannot clean the areas around the heating element array.

Taking advantage of the elasticity of the platen roller, it is possible to enlarge the contact area between the cleaning sheet and the partial glaze to some extent by increasing the torque of the platen roller such that the platen roller is deformed along the cylindrical periphery of the partial glaze, covering the top area of the heating element array. Still, it is not easy to deform the platen roller so as to stretch over the entire stained area because of a limitation in the elastic deformation of the platen roller. Even if it is assumed that the contact area would be enough expanded by the deformed platen roller, the pressure is focused on a particular part in the contact area and such uneven pressure prevents efficient cleaning in the entire contact area.

### SUMMARY OF THE INVENTION

An object of the present invention is to provide a device and a method for cleaning the thermal head that are capable of efficiently removing stains on a heating element array and its vicinity.

In order to achieve the above object and other objects, a device of the present invention for cleaning the thermal head is provided with a push member for pushing a cleaning sheet to the thermal head, and a reciprocating mechanism for reciprocating the push member along a head surface of the thermal head in a transporting direction of the cleaning sheet. The cleaning sheet is reciprocated in a sub-scanning direction in a head cleaning operation.

In the present embodiment, the push member is a roller to be eccentrically rotated by movement of the cleaning sheet. The reciprocating mechanism includes a rotary axis at the center of the roller, two eccentric bearings (eccentric discs), a guide member for rotatably supporting the eccentric bearing, and a biasing member for biasing the roller to the thermal head. At two spots in the sub-scanning direction, the guide member rotatably clamps the eccentric bearings so as to move the rotary axis in the sub-scanning direction and the vertical direction when the eccentric bearings rotate together with the roller.

In another embodiment of the present invention, a platen roller rotates eccentrically. This platen roller pushes a thermal recording paper in printing operation, and the cleaning sheet in the head cleaning operation to the thermal head. A normal bearing with no eccentricity is fixed to the rotary axis of the platen roller next to each eccentric bearing. A cam mechanism fits the normal bearings into the guide member in printing, while it fits the eccentric bearings into the guide member in the head cleaning.

In the head cleaning method of the present invention, the cleaning sheet is reciprocated in the sub-scanning direction, being pushed to the thermal head by the roller. The stain on the head surface is rubbed off by the cleaning sheet, as the roller is reciprocating along the head surface of the thermal head.

According to the present invention, it is possible to expand the cleaning area because the push member for pushing the cleaning sheet is reciprocated along the head surface in the sub-scanning direction. Thereby, the vicinity of the heating element array as well as the heating element array is efficiently cleaned up.

In a preferred embodiment of the present invention, the platen roller is slidably disposed, and the eccentric bearing and the normal bearing are fixed to the axis of the platen roller. In the head cleaning operation, the platen roller is simply slid and fits the eccentric bearing into the guide member. The constitution is thus simple and enables easy switching of the operation between the printing operation and the head cleaning operation.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a schematic view illustrating a color thermal printer to which the present invention is applied;

FIG. 2 is a partial perspective view illustrating a thermal head;

FIG. 3 is a perspective view illustrating a platen roller reciprocating mechanism;

FIGS. 4A and 4B are front views illustrating a bearing changeover mechanism;

FIG. 5 is an explanatory view illustrating a shift trajectory of the platen roller; and

FIG. 6 is a perspective view illustrating a cylindrical end cam.

### PREFERRED EMBODIMENTS OF THE INVENTION

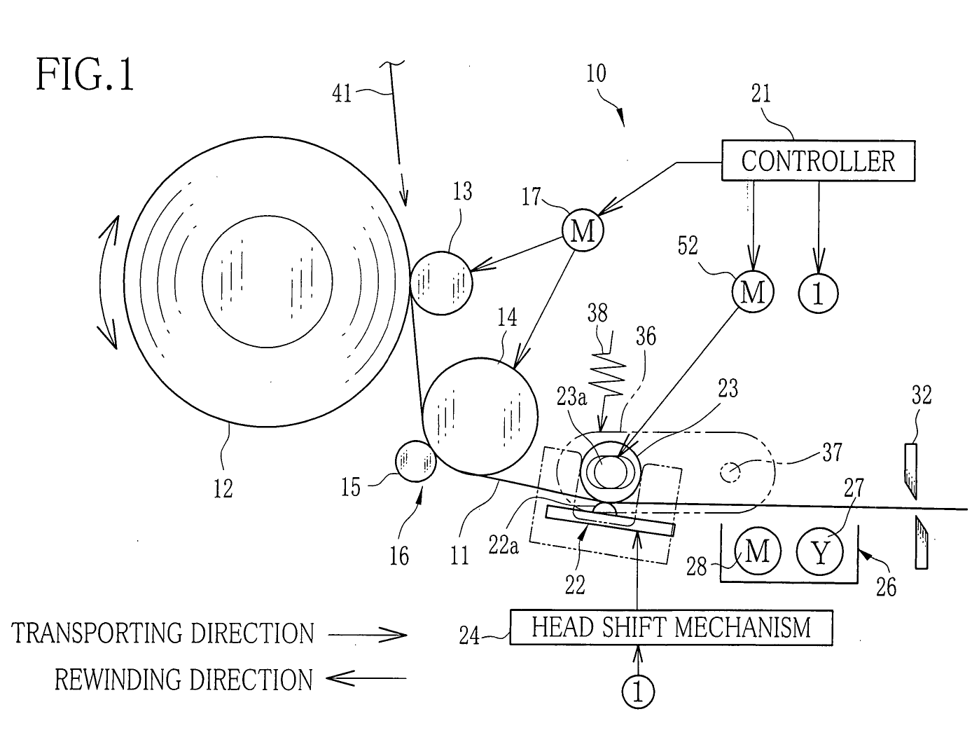

As shown in FIG. 1, a recording paper roll 12 of a roll-shaped continuous recording paper 11 is loaded in a color direct thermal printer 10. As is well known in the art, the recording paper 11 comprises a cyan thermosensitive coloring layer, a magenta thermosensitive coloring layer, and a yellow thermosensitive coloring layer laminated on a support in the stated order. The yellow thermosensitive coloring layer on top of the other thermosensitive coloring layers has the highest thermosensitiveity among the three thermosensitive coloring layers and develops the yellow color with low thermal energy. The cyan thermosensitive coloring layer under the other thermosensitive coloring layers has the lowest thermosensitivity among the three thermosensitive coloring layers and needs high thermal energy to develop the cyan color.

The yellow thermosensitive coloring layer loses its ability to develop the yellow color when exposed to a yellow fixing light, which is blue-violet visible light having an emission wavelength peak at 420 nm. The magenta thermosensitive coloring layer develops the magenta color by thermal energy level between the one for the yellow color and the other for the cyan color. The magenta thermosensitive coloring layer loses its ability to develop the magenta color when exposed to a magenta fixing light, near ultraviolet rays having the emission wavelength peak at 365 nm. A protective layer formed of transparent resin is laminated on the yellow thermosensitive coloring layer for protecting the thermosensitive coloring layers.

A feed roller 13 contacts and rotates the recording paper roll 12 to draw the front end of the recording paper 11 from the recording paper roll 12. A transport roller pair 16, comprising a capstan roller 14 and a pinch roller 15, is disposed at the downstream side of the feed roller 13. The transport roller pair 16 nips and transports the recording paper 11 in a transporting and a rewinding directions. A transportation path is formed of a guide member (not shown) for guiding the recording paper 11.

The feed roller 13 and the transport roller pair 16 are rotated in both normal and reverse directions by a transport motor 17. The transport motor 17 is a stepping motor, for example. The rotating speed and the rotating amount of the transport motor 17 are controlled by a controller 21 via a motor driver (not shown). By counting the driving pulse for the transport motor 17, the controller 21 identifies a recording start position, a cutting position, and the transporting amount of the recording paper 11.

A thermal head 22 is provided at the downstream side of the transport roller pair 16 to be driven by a head driver based on the image data sent from the controller 21. The thermal head 22 is provided with a heating element array 22a, in which a plurality of heating elements are aligned in a main scanning direction. As pressing the heating element array 22a against the recording paper 11, the thermal head 22 heats each heating element to supply the recording paper 11 with the heat energy in accordance with the gradation value of the image data. This thermal recording by the thermal head 22 is performed while the recording paper is transported in the rewinding direction.

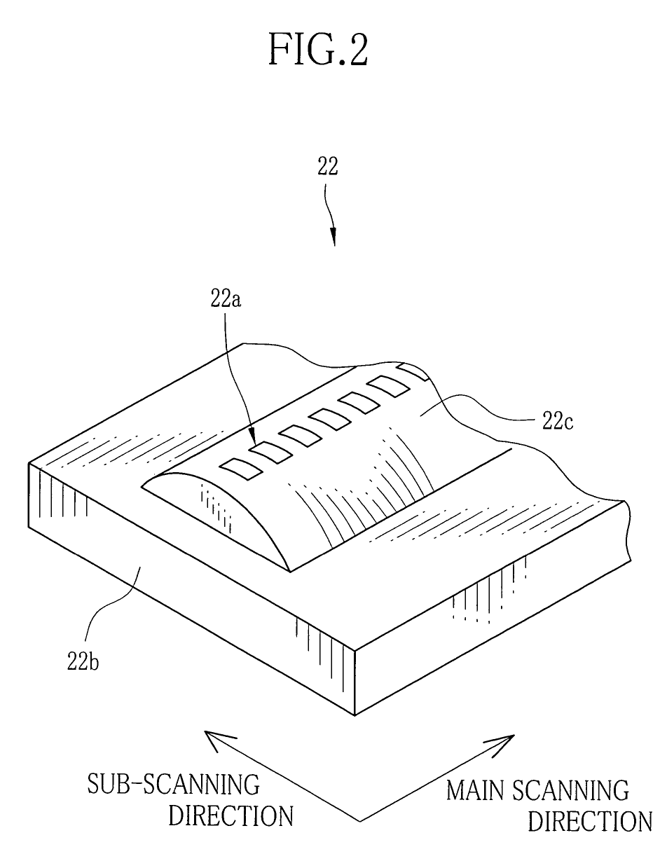

As shown in FIG. 2, the thermal head 22 comprises a head substrate 22b formed of ceramic and a partial glaze 22c, which is a cylindrical projection, formed on the head substrate 22b and provided with the heating element array 22a on approximately top thereof. The area including the partial glaze 22c and its vicinity is referred to as a head surface.

When the heating element array 22a heats the recording paper 11, the protective layer forming the surface of the recording paper 11 melts and stains on the head surface in the sub-scanning direction of the heating element array 22a. Since the stain has an adverse affect on image quality such as reducing the recording density and scratching the surface of the recording paper 11, a head cleaning operation is performed.

A platen roller 23 is disposed opposite to the heating element array 22a to support the recording paper 11 on its rear face. The platen roller 23 is rotated by the movement of the recording paper 11 and secures the contact between the recording paper 11 and the heating element array 22a. As nipped by the thermal head 22 and the platen roller 23, the recording paper 11 is pushed to the heating element array 22a.

The platen roller 23 is rotatably supported and each end of a rotary axis 23a is inserted into a hole at an end of a swing arm 36. An axis 37 is inserted into the other end of the swing arm 36 for swingably supporting the swing arm 36. The swing arm 36 is biased by a spring 38 to shift the platen roller 23 to the thermal head 22.

The head shift mechanism 24 moves the thermal head 22 between a retreat position that provides a space between the heating element array 22a and the platen roller 23 and a pressing position for pressing the heating element array 22a against the recording paper 11. Since the swinging range of the swing arm 36 is limited by a control member (not shown), the platen roller 23 does not move following the thermal head 22 moving to the retreating position. In recording operation, the thermal head 22 moves to the pressing position to press the heating element array 22a against the recording paper 11. Note that it is also possible to fix the thermal head 22 and move the platen roller 23, instead of moving the thermal head 22 to press against the recording paper 11.

An optical fixer 26 is disposed at the downstream side of the thermal head 22. The optical fixer 26 is provided with a yellow-fixing lamp 27 and a magenta-fixing lamp 28 for emitting yellow-fixing light and magenta-fixing light respectively. In order to fix a yellow image, after the thermal recording of the yellow image the yellow-fixing lamp 27 is lit up to emit the yellow fixing light to the yellow image while a recording area of the recording paper 11 is transported in the transporting direction, which is the opposite direction for thermal recording. Subsequently, the yellow-fixing lamp 27 is turned off and a magenta image is thermally recorded as the recording area is transported in the rewinding direction. After the thermal recording of the magenta image, the magenta-fixing lamp 28 is lit up to fix the magenta image while the recording area is transported in the transporting direction. After the recording area passes the optical fixer 26, the recording area is transported in the rewinding direction to start recording a cyan image.

A cutter 32 is provided at the downstream side of the optical fixer 26 to cut the recording area into a sheet after thermal recording and optical fixing. A cut-off sheet is discharged out of the printer via a discharge opening. Unrecorded area of the recording paper 11 is rewind to the recording paper roll 12.

A cleaning sheet 41, coated with abrasives, is used to clean the thermal head 22. The cleaning sheet 41 instead of the recording paper 11 is fed into the transport path. The cleaning sheet 41 rubs the stain off the head surface when nipped by the transport roller pair 16 and reciprocated sliding on the thermal head 22 in the sub-scanning direction.

In the head cleaning operation, the platen roller 23 functions as a cleaning roller to push the cleaning sheet 41 to the thermal head 22. The platen roller 23 is rotated by the movement of the cleaning sheet 41 being transported, and reciprocates in the sub-scanning direction so as to expand the contact area between the cleaning sheet 41 and the partial glaze 22c to be larger than that between the recording paper 11 and the partial glaze 22c in the recording operation.

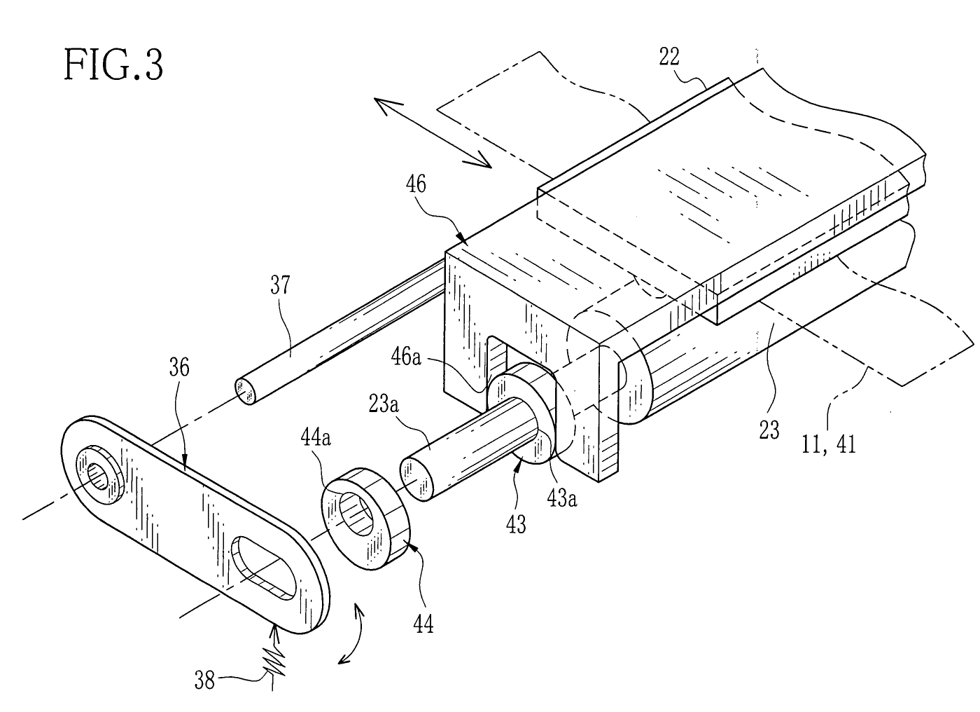

As shown in FIG. 3, a normal bearing (disc) 43 and an eccentric bearing (eccentric disc) 44 are attached to the rotary axis 23a of the platen roller 23 for rotatably supporting the rotary axis 23a. The normal bearing 43 is a standard bearing having a bearing hole 43a at the center, in which the rotary axis 23a is inserted. On the other hand, the eccentric bearing 44 has a bearing hole 44a which is aside from the center. Each of the bearings 43 and 44 is selectively fitted into a notch or an opening formed on a holding member (guide member) 46 fixed to the thermal head 22.

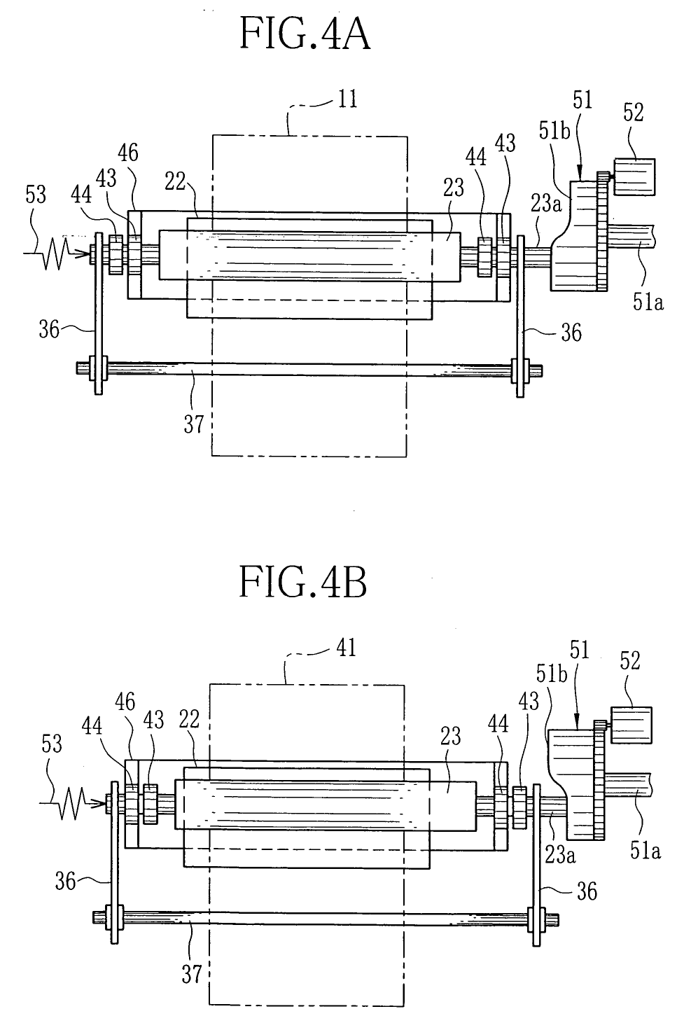

In printing operation, the normal bearing 43 fits into the fitting section 46a as shown in FIG. 4A. The platen roller 23 thus rotates without moving in the sub-scanning direction. In the head cleaning operation, the platen roller 23 slides in the main scanning direction together with the rotary axis 23a to fit the eccentric bearing 44 into the fitting section 46a, as shown in FIG. 4B. Thus it enables the platen roller 23 to reciprocate in the sub-scanning direction along the periphery of the partial glaze 22c.

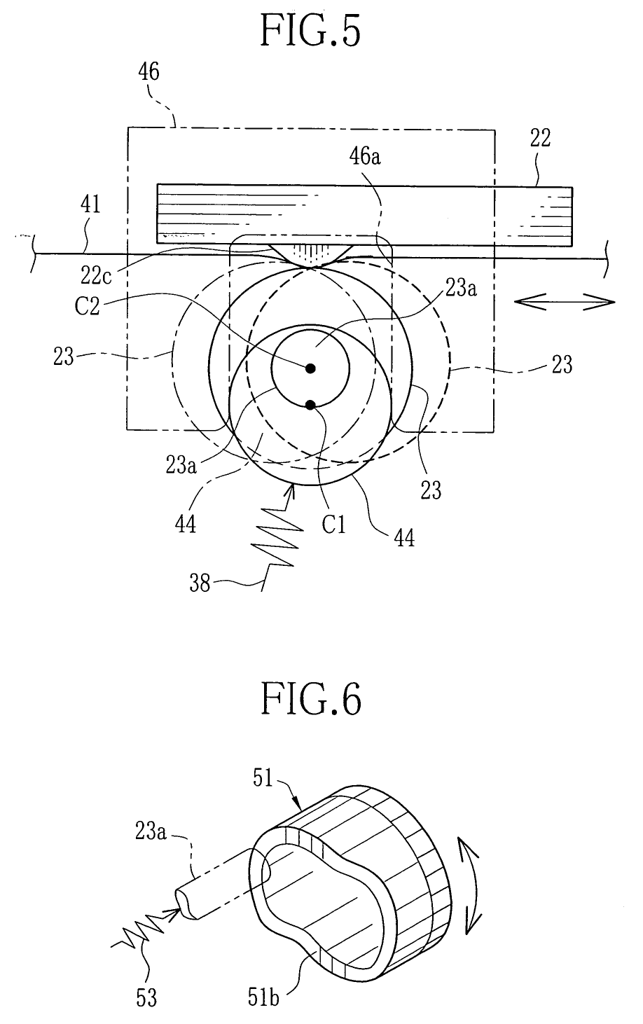

FIG. 5 shows shift trajectories of the platen roller 23 and the rotary axis 23a in the head cleaning operation. The platen roller 23 is rotated by the movement of the cleaning sheet 41 and reciprocates in the sub-scanning direction shown by the arrow in FIG. 5. Since a rotary center C2 is aside from the rotary center C1 of the eccentric bearing 4, the platen roller eccentrically rotates moving up and down and backward and forward. That is, the platen roller 23 eccentrically reciprocates between the front position shown by the dashed chain line and the rear position shown by the dotted line.

The thermal head 22 is positioned not to move in the vertical direction, and the platen roller 23 is biased to the thermal head 22 by the spring 38. Thereby, the movement of the rotary axis 23a in the vertical direction accompanying the rotation of the eccentric bearing 44 is absorbed by the movements of the eccentric bearing 44 and the platen roller 23 in the vertical direction.

When reciprocating forward and backward, the platen roller 23 is deformed along the surface of the partial glaze 22c with the bias of the spring 38. The cleaning sheet 41 thus contacts the partial glaze 22c and its vicinity, efficiently scraping the stains off both the heating element array 22a and its vicinity.

The reciprocating range of the platen roller 23 is determined by the eccentricity of the eccentric bearing 44, which is a distance between the center C1 of the eccentric bearing 44 and the center C2 of the rotary axis 23a. Accordingly, the cleaning area is adjusted simply by changing the eccentricity, which allows greater flexibility in designing.

A changeover mechanism for changing between the normal bearing 43 and the eccentric bearing 44 comprises a cylindrical end cam 51 with a cam surface 51b that contacts one end of the rotary axis 23a, and a changeover motor 52 for rotating the cylindrical end cam 51. An axis 51a of the cylindrical end cam 51 is disposed parallel to the rotary axis 23a of the platen roller 23. The rotary axis 23a is pressed against the cam surface 51b by the bias of the spring 53.

As shown in FIG. 6, the cam surface 51b curves to have different heights so as to shift the rotary axis 23a with the rotation of the cylindrical end cam 51. The rotary axis 23a follows the edge of the cam surface 51b, shifting in the main scanning direction because of the change in height of the cam surface 51b. Accordingly, the cylindrical end cam 51 fits the normal bearing 43 into the fitting section 46a when the rotary axis 23a contacts the higher portion of the cam surface 51b, while the cylindrical end cam 51 fits the eccentric bearing 43 into the fitting section 46a when the rotary axis 23a contacts the lower portion of the cam surface 51b. A gear formed on the cylindrical end cam 51 engages with the changeover motor 52 such that the cylindrical end cam 51 is rotated by the driving force of the changeover motor 52.

In the head cleaning operation, a user feeds the cleaning sheet 41 into the transportation path and then sends out a cleaning command by operating an operating section. Then, the controller 21 sets the cleaning mode and drives the changeover motor 52 to changeover the bearings.

Following is an explanation about the operation of the above constitution. In the print mode, the normal bearing 43 is fitted into the fitting section 46a, as shown in FIG. 4A. The recording paper 11 starts being fed in response to a print command. When the front end of the recording paper 11 passes the thermal head 22, the thermal head 22 shifts to the pressing position for nipping the recording paper with the platen roller 23 such that the heating element array 22a presses against the recording paper 11. In this state, the recording paper 11 is reciprocated in the sub-scanning direction while the thermal head 22 thermally records and the optical fixer 26 optically fixes the image.

Since the normal bearing is fitted into the fitting section 46a, the platen roller 23 does not move in the sub-scanning direction and stays in the position for pushing the recording paper 11 to the heating element array 22a while being rotated by the movement of the recording paper 11. The contact between the heating element array 22a and the recording paper 11 is thus secured, which enables the proper recording of the image.

In the head cleaning operation, the user feeds the cleaning sheet 41 into the transportation path and sends out the cleaning command by operating the operating section. Then, the cylindrical end cam 51 rotates, shifting the rotary axis 23a in the main scanning direction such that the eccentric bearing 44 replaces the normal bearing 43 and fits into the fitting section 46a.

When the front end of the cleaning sheet 41 passes the thermal head 22, the thermal head 22 moves to the pressing position and the cleaning sheet 41 is nipped by the thermal head 22 and the platen roller 23. In this state, the cleaning sheet 41 is reciprocated by the transport roller pair 16 in the sub-scanning direction on the transportation path. The platen roller 23 is rotated by the movement of the cleaning sheet 41. In the cleaning mode, the rotary axis 23a eccentrically rotates because of the eccentric rotation of the eccentric bearing 44 within the fitting section 46a by the guide thereof. The platen roller 23 reciprocates backward and forward from the heating element array 22a in the sub-scanning direction. Biased by the spring 38 to the partial glaze 22c, the platen roller 23 moves along the surface of the partial glaze 22c. The cleaning sheet 41 thus rubs the heating element array 22a and its vicinity.

Since the cleaning sheet 41 is pushed to the vicinity of the heating element array 22a by the platen roller 23 eccentrically rotating, the stain thereon is efficiently removed.

Note that the platen roller reciprocating mechanism is not limited to the eccentric bearing and the holding member but may be arranged in a various ways. In addition, it is possible to fix the platen roller with regard to the sub-scanning direction and reciprocate the thermal head in the sub-scanning direction in the head cleaning operation, though the thermal head is fixed with regard to the sub-scanning direction and the platen roller is reciprocated in the sub-scanning direction in the above embodiment. Although the platen roller functions as the cleaning roller as well in the above embodiment, it is also possible to provide an exclusive cleaning roller that faces the thermal head instead of the platen roller in the head cleaning operation. Furthermore, a push member for pushing the cleaning sheet 41 may be a rod with a round end.

Although the above embodiment is exemplified by the thermal printer using the thermal recording paper, the present invention is also applicable to a thermal transfer printer that transfers ink of a ink sheet to a paper.

Although the present invention has been described with respect to the preferred embodiments, the present invention is not to be limited to the above embodiments but, on the contrary, various modifications will be possible to those skilled in the art without departing from the scope of claims appended hereto.

1. A device for cleaning a thermal head with a cleaning sheet, said thermal head including a head surface of circular arc shape extending in a main scanning direction and a heating element array formed on approximately top of said head surface, said device comprising:
a push member for pushing said cleaning sheet to said thermal head; and
a reciprocating mechanism for reciprocating said push member along said head surface in a sub-scanning direction orthogonal to said main scanning direction, so as to contact said cleaning sheet with said head surface.

2. A device defined in claim 1, wherein said cleaning sheet reciprocates in said sub-scanning direction in a head cleaning operation.

3. A device defined in claim 2, wherein said push member is a roller to be rotated by movement of said cleaning sheet.

4. A device defined in claim 3, wherein said reciprocating mechanism eccentrically rotates said roller.

5. A device defined in claim 4, wherein said reciprocating mechanism comprising:
a roller axis located at the center of said roller;
an eccentric bearing fixed to said roller axis;
a guide member for rotatably supporting said eccentric bearing at two or more points in said sub-scanning direction, said guide member supporting said rotary axis to move in a vertical and said sub-scanning directions during rotation of said eccentric bearing and said roller; and
an urging member for biasing said roller to said thermal head.

6. A device defined in claim 5, wherein said guide member has a notch in which said eccentric bearing rotatably fits.

7. A device defined in claim 6, wherein said roller is a platen roller for pushing a recording paper to said thermal head in printing operation, and for pushing said cleaning sheet to said thermal head in said head cleaning operation.

8. A device defined in claim 7, further comprising:
a normal bearing fixed to said roller axis next to said eccentric bearing, said normal bearing being not eccentric; and
a cam mechanism for sliding said roller axis, said cam mechanism fitting said normal bearing into said notch in said printing operation and fitting said eccentric bearing into said notch in said head cleaning operation.

9. A method for cleaning a thermal head, said thermal head including a head surface of circular arc shape extending in a main scanning direction and a heating element array formed on approximately top of said head surface, said method comprising:
reciprocating a cleaning sheet in a sub-scanning direction orthogonal to said main scanning direction; and
reciprocating a roller along said head surface in said sub-scanning direction while said cleaning sheet being transported.
